(19) United States
(12) Patent Application Publication
(10) Pub. No.: US 2013/0050902 A1
(43) Pub. Date: Feb. 28, 2013

(54) ELECTRODE ACTIVE MATERIAL, METHOD FOR PREPARING THE SAME, AND ELECTROCHEMICAL CAPACITOR INCLUDING ELECTRODE USING THE SAME

(71) Applicants: Hak Kwan KIM, Seoul (KR); Jun Hee BAE, Seoul (KR); Bae Kyun KIM, Gyeonggi-do (KR); Ho Jin YUN, Gyeonggi-do (KR)

(72) Inventors: Hak Kwan KIM, Seoul (KR); Jun Hee BAE, Seoul (KR); Bae Kyun KIM, Gyeonggi-do (KR); Ho Jin YUN, Gyeonggi-do (KR)

(73) Assignee: Samsung Electro-Mechanics Co., Ltd., Suwon (KR)

(21) Appl. No.: 13/467,632

(22) Filed: May 9, 2012

(30) Foreign Application Priority Data
Aug. 23, 2011 (KR) 10-2011-0084180

(51) Int. Cl. H01G 9/042; H01G 9/048; H01B 5/00; H01B 1/04

(52) U.S. Cl. 361/500; 252/510; 174/126.1

(57) ABSTRACT

An electrode active material including a first layer formed on a surface of activated carbon and having a porous structure, and a second layer formed on the first layer and having polar groups, a method for preparing the same, and an electrochemical capacitor including an electrode using the same. There can be provided an electrode active material for an electrochemical capacitor having improved performances in which capacitance per unit weight is large, inner resistance is small, and performance is not largely deteriorated even at high current. Furthermore, high-priced activated carbon mainly dependent on imports can be substituted with low-priced activated carbon prepared by double surface treatment, and thus superior economical effects can be obtained.

### CROSS REFERENCE(S) TO RELATED APPLICATIONS

This application claims the benefit under 35 U.S.C. Section 119 of Korean Patent Application Serial No. 10-2011-0084180, entitled “Electrode Active Material, Method for Preparing the Same, and Electrochemical Capacitor Including Electrode Using the Same” filed on Aug. 23, 2011, which is hereby incorporated by reference in its entirety into this application.

### BACKGROUND OF THE INVENTION

1. Technical Field

The present invention relates to an electrode active material, a method for preparing the same, and an electrochemical capacitor including an electrode using the same.

2. Description of the Related Art

In general, an electronic component, called a capacitor, stores electricity in a physical mechanism without chemical reaction or phase change, and functions to collect and then send out the electricity to stabilize electric current within a circuit. This capacitor has a very short charging and discharging time, long lifespan, and very high output density, but is limited in the use as an energy storage device due to very small energy density thereof.

In contrast, a secondary battery can store high-density energy, and has been used as an energy storage medium for portable electronic applications, such as a notebook, a cellular phone, a PDA, and the like. A lithium ion battery is generally referred to as the secondary battery.

There is also an electrochemical capacitor, which expresses medium characteristics between the capacitor and the secondary battery and thus to be used as a storage medium of an electronic application requesting high energy density and high output density. The electrochemical capacitor is also called a supercapacitor, an electrical double layer capacitor (EDLC), an ultracapacitor, and the like.

The electrochemical capacitor is potentially applicable as various fields of energy storage media, such as wind power generation, a hybrid electric vehicle (HEV), an electric vehicle (EV), and the like, and thus receives explosive interests over the world.

The most important core of the supercapacitor is an electrode material. The electrode material needs to have a high specific surface area above all, a large electric conductivity so that charges make the minimum voltage drop distribution at an electrode, electrochemical stability at a predetermined potential, and low price for commercialization.

These supercapacitors can be largely divided into three types of supercapacitors depending on the electrode and mechanism.

First, there is an electrical double layer capacitor (EDLC), which uses an activated carbon for an electrode and has a mechanism of electric double layer charging or electrostatic adsorption.

Second, there is a pseudocapacitor or a redox capacitor, which uses transition metal oxide or conductive polymer as an electrode material and has a mechanism of pseudo-capacitance from chemically oxidation and reduction reaction.

Third, there is a hybrid capacitor having medium characteristics between the electric double layer capacitor and the redox capacitor.

In addition, the supercapacitor is operated by an electrochemical mechanism generated by applying a voltage with several volts to both ends of an electrode of a unit cell, and thereby allowing ions within an electrolyte to move along electric fields and adsorb a surface of the electrode.

Meanwhile, a basic structure of this supercapacitor consists of a porous electrode, an electrolyte, a current collector, and a separator.

The porous electrode may be formed by mixing an active material, a conductive material, a binder, a solvent, and other additives to prepare a slurry and coating the slurry on the current collector. Activated carbon is mainly used as the active material of the electrode while it has porosity in a surface thereof. Considering that specific capacitance is proportional to a specific surface area, the activated carbon increases energy density due to high capacitance of an electrode material.

Furthermore, while the active material slurry is coated and dried on the current collector, the binder is attached between the active material and the active material and between the active material and the current collector to form the electrode. The binder is one of the important factors in determining a performance of the capacitor. If the performance of the binder is deteriorated or an appropriate amount of binder is not contained within the electrode, it is difficult to form a film with uniform thickness at the time of coating the electrode. Furthermore, the active material becomes detached from the active material or the current collector, which decreases a capacitance of the capacitor or increases an inner resistance, even after the capacitor is constituted. Whereas, if the amount of binder is excessively large, the amount of active material within the electrode is reduced, with the result that the capacitance of the capacitor is deteriorated, or the inner resistance is increased because most polymers are electrical nonconductors.

Currently, activated carbon, conductive carbon, conductive polymer, transition metal oxide, and the like are used as an electrode material for a supercapacitor. Among them, carbon materials and the like are easy to prepare, but carbon used as a raw material, which is produced in Korea, has many impurities and a small specific surface area, and thus, most carbon is being imported from overseas. Furthermore, most activated carbon for an EDLC is expensive. Therefore, carbon materials cost too much. Furthermore, general metal oxides have small specific surface areas and large resistances even though they have excellent electric property, and thus, they have many limitations in actual application thereof.

Therefore, there are demands for developing electrode materials for a supercapacitor which has a low price and excellent physical properties.

### SUMMARY OF THE INVENTION

An object of the present invention is to provide an electrode active material for use in an electrochemical capacitor having high capacitance and low resistance.

Another object of the present invention is to provide a method for preparing the electrode active material.

Still another object of the present invention is to provide an electrochemical capacitor using the electrode active material.

According to an exemplary embodiment of the present invention, there is provided an electrode active material, including: a first layer formed on a surface of activated carbon and having a porous structure; and a second layer formed on the first layer and having polar groups.

The electrode active material may have a specific surface area of 2,000 to 3,000 m²/g.

The polar groups of the second layer may be obtained by substitution of carbon bonds on a surface of the first layer.

The polar group of the second layer may be at least one nitrogen-containing material selected from the group consisting of a C═N group, an amino group, a cyclic amide group, a nitrile group (RCN, wherein R is a hydrocarbon group), and a 5-membered heterocyclic compound containing one nitrogen atom in a ring thereof, but not limited thereto.

The second layer may be formed to have a thickness of 10 nm or less.

According to another exemplary embodiment of the present invention, there is provided a method for preparing an electrode active material, including: performing heat treatment on activated carbon to form a first layer having a porous structure; and substituting carbon bonds on a surface of the first layer with polar groups to form a second layer having the polar groups.

The heat treatment may be performed by using an aqueous alkaline solution.

The heat treatment may be performed at a temperature of 300 to 700° C. for 1 to 3 hours.

The substituting with the polar group may be performed by one method selected from plasma treatment, nitric acid oxidation, and ammonia treatment.

According to another exemplary embodiment of the present invention, there is provided an electrochemical capacitor using an electrode active material including a first layer formed on a surface of activated carbon and having a porous structure, and a second layer formed on the first layer and having polar groups.

### BRIEF DESCRIPTION OF THE DRAWINGS

FIGS. 1 and 2 each show a structure of an electrode active material according to the present invention.

### DESCRIPTION OF THE PREFERRED EMBODIMENTS

Hereinafter, the present invention will be described in more detail.

Terms used in the present specification are for explaining the embodiments rather than limiting the present invention. As used herein, unless explicitly described to the contrary, a singular form includes a plural form in the present specification. Also, used herein, the word “comprise” and/or “comprising” will be understood to imply the inclusion of stated constituents, steps, operations and/or elements but not the exclusion of any other constituents, steps, operations and/or elements.

The present invention is directed to an electrode active material for an electrochemical capacitor, a method for preparing the same, and an electrochemical capacitor using the same.

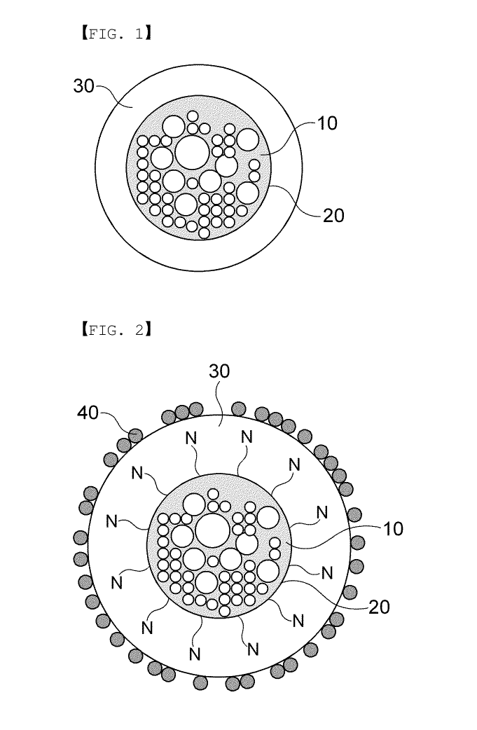

An electrode active material according to one exemplary embodiment of the present invention has a structure as shown in FIG. 1. Referring to this drawing, the electrode active material may include a first layer 20 formed on a surface of activated carbon 10 and having a porous structure; and a second layer 30 formed on the first layer 20 and having a polar group.

In other words, the activated carbon is used for the electrode active material, and a surface treatment procedure is performed two times, thereby preparing an activated carbon powder having a double layer structure.

The activated carbon is subjected to heat treatment to form innumerable pores in a surface thereof, resulting in the first layer having a porous structure. Therefore, the activated carbon in the first layer advantageously has a specific surface area of 2000 m²/g˜3,000 m²/g, so that a ratio of effective porosity is maximized and a capacitance is increased.

The existing activated carbon used for an electrode active material had previously a porous structure in a surface thereof, and such products were commercially purchased for use. This activated carbon is easy to use, but unit cost thereof is very high, and thus an economical burden is enlarged when it is applied to actual products in a large amount.

However, according to the present invention, an activated carbon powder having a desired specific surface area can be prepared by performing heat treatment on raw activated carbon in an appropriate way.

Therefore, when the activated carbon powder is used for an electrode active material of an electrochemical capacitor, an increase in capacitance per unit weight or unit volume can be anticipated.

In the electrode active material according to the present invention, the second layer, which is a polar layer including polar groups, is formed on the first layer. The second layer is formed by substituting carbon bonds on a surface of the first layer with the polar group.

In other words, since general activated carbon mostly consists of only carbon, it has mainly very high hydrophobicity. Therefore, in cases where this is used for an electrode active material, counter ions of an electrolyte have a relatively low adsorption/desorption ratio.

Therefore, according to the present invention, the polar layer is formed by substituting the carbon bonds with the polar groups, in order to solve the hydrophobicity problem of this activated carbon.

As the polar group of the second layer used herein, at least one nitrogen-containing compound selected from the group consisting of a C═N group, an amino group, a cyclic amide group, a nitrile group (RCN, wherein R is a hydrocarbon group), and a 5-membered heterocyclic compound containing one nitrogen atom in a ring thereof (for example, pyrrole or the like) may be used.

In addition, the second layer, which is a polar layer, is preferably formed with a thickness of 10 nm or less, and thus, an increase in resistance of cells due to formation of the polar group can be minimized and capacitance per unit weight or unit volume can be maximized.

Hereinafter, a method for preparing an electrode active material according to the present invention will be described in detail.

Referring to FIG. 2, as a first step, activated carbon 10 is subjected to heat treatment, to form a first layer 20 having a porous structure in a surface thereof.

As raw activated carbon, wood, lignite, peat and coal, or, farming wastes or byproducts (for example, macadamia nut shell, coconut shell, paper factory sludge, peach seed, palm Kernel shell, or the like) may be used, but not particularly limited thereto.

An aqueous alkaline solution is added to the activated carbon, followed by heat treatment at a relatively low temperature, with the result that innumerable pores are formed in the surface of the activated carbon by intercalation of alkaline metal through the heat treatment.

The aqueous alkaline solution may be formed by using NaOH or KOH, but not limited thereto.

In addition, the heat treatment is preferably performed at a temperature of 300 to 700° C. for 1 to 3 hours.

As a result, activated carbon having a porous structure and a specific surface area of 2,000 m²/g to 3,000 m²/g can be prepared.

As a second step, carbon bonds on the surface of the first layer are substituted with polar groups, to form a second layer having a polar group.

The second step is performed in order to remove impurities that may be generated after the first heat treatment and to substitute carbon bonds on the surface of the first layer with the polar group to change a binding energy.

As the polar group of the second layer used herein, at least one nitrogen-containing material selected from the group consisting of a C═N group, an amino group, a cyclic amide group, a nitrile group (RCN, wherein R is a hydrocarbon group), and a 5-membered heterocyclic compound containing one nitrogen atom in a ring thereof (for example, pyrrole or the like) may be used.

In other words, as shown in FIG. 2, when carbon bonds (C) on the surface of the activated carbon is substituted with the polar group, such as nitrogen (N), nitrogen (N) atoms, which are polar groups, surround the first layer, thereby forming a second layer 30. Therefore, the number of N-type configuration distribution sites is relatively increased as compared with a surface of untreated activated carbon. For this reason, a binding strength with counter ions 40 in the electrolyte is increased to enable adsorption and desorption of more ions.

Therefore, when this structured active material is used for an electrode, capacitance is increased. Furthermore, it can be estimated that a loss in power density is minimized because ion adsorption and desorption on the surface are increased in view of mechanism.

According to one exemplary embodiment of the present invention, the substitution with the polar groups may be performed by using one method selected from plasma treatment, nitric acid oxidation, and ammonia treatment.

In addition, the activated carbon prepared by the above procedure is used as an electrode active material, and a conductive material, a binder, a solvent, and other additives are mixed thereto, thereby preparing an electrode active material slurry.

The conductive material, the binder, the solvent, and other additives may be used within a range in which physical properties of the electrode active material of the present invention is not destroyed. Materials that are conventionally used in the electrochemical capacitor may be used, and kinds and contents thereof are not particularly limited.

In addition, the present invention can provide an electrochemical capacitor including an electrode using the electrode active material slurry.

An electrode according to the present invention may be used as a cathode and/or an anode.

In addition, a current collector, an electrolyte, a separator, and the like constituting the electrochemical capacitor of the present invention is not particularly limited, as long as they are used in the electrochemical capacitor such as a general electrical double layer capacitor, and detail descriptions thereof will be omitted.

Hereinafter, exemplary embodiments of the present invention will be described in detail. The following examples are only for illustrating the present invention, and the scope of the present invention should not be interpreted as being limited by these examples. In addition, specific compounds are used in the following examples, but it is obvious to those skilled in the art that equivalents thereof can exhibit the same or similar degrees of effects.

### Example 1

### Preparation of Electrode Active Material

A first surface treatment, which is an alkaline activation procedure, was performed by mixing activated carbon, which is prepared by using coconut shell raw materials, with KOH salt, followed by heat treatment at 700° C. for 2 hours, thereby preparing activated carbon having porosity in a surface thereof.

Then, a second surface treatment was performed according to the following procedure. The first surface treatment-completed activated carbon was kept in a quartz tube furnace at 150° C. for 48 hours, so as to remove moisture therefrom. Then, nitrogen plasma treatment was performed at a vacuum atmosphere, thereby substituting carbon bonds on a surface of the first surface treated activated carbon with nitrogen atoms. Here, as for a power, 500 W and 4 Torr were kept, and a flow rate of nitrogen gas was kept 91 sccm.

The prepared activated carbon had a specific surface area of 2570 m²/g.

### Example 2

### Preparation of Composition for Electrode Active Material Slurry

85 g of activated carbon (specific surface area: 2570 m²/g) prepared in the example 1, 18 g of Super-P as a conductive material, 3.5 g of CMC as a binder, 12.0 g of SBR, and 5.5 g of PTFE were mixed with 250 g of water, followed by mixing and stirring, thereby preparing a composition for an electrode active material slurry.

### Comparative Example 1

85 g of general activated carbon (specific surface area: 2150 m²/g) which is surface-untreated, 18 g of Super-P as a conductive material, 3.5 g of CMC as a binder, 12.0 g of SBR, and 5.5 g of PTFE were mixed with 225 g of water, followed by mixing and stirring, thereby preparing an electrode active material slurry.

### Example 3, Comparative Example 2

### Manufacture of Electrochemical Capacitor

1) Preparation of Electrode

The electrode active material slurry according to each of Example 2 and Comparative Example 1 was coated on an aluminum etching foil with a thickness of 20 μm using a comma coater, followed by temporary drying, and then cut into electrodes with a size of 50 mm×100 mm. The electrode had a cross-sectional thickness of 60 μm. The electrode was dried under vacuum at 120° C. for 48 hours, before assembling a cell.

2) Preparation of Electrolyte

Spiro-based salt was dissolved in an acrylonitrile solvent to a concentration of 1.3 mol/L, thereby preparing an electrolyte.

3) Assembling of Capacitor Cell

A separator (TF4035 from NKK, cellulose-based separator) was inserted between the prepared electrodes (cathode and anode), followed by impregnation with the electrolyte, and then the resulting structure was put and sealed in a laminate film case.

### Experimental Example

### Evaluation on Capacitance of Electrochemical Capacitor Cell

Under the condition of constant temperature of 25° C., the cell was charged to 2.5V at a current density of 1 mA/cm² in a constant current-constant voltage mode, and then kept for 30 minutes. Then, the cell was discharged at a constant current of 1 mA/ni three times, and then capacitance at the last cycle was measured. The results were tabulated in Table 1.

Resistance property of each cell was measured by an ampere-ohm meter and an impedance spectroscopy, and the results were tabulated in Table 1.

TABLE 1

| | | Resistance |
|---|---|---|
| | Initial capacitance (F) | (AC ESR, mΩ) |
| Comparative Example 2 | 10.78 | 19.03 |
| Example 3 | 13.21 | 18.77 |

As seen from the results of Table 1, an electrochemical capacitor (EDLC cell) according to Comparative Example 2, which includes an electrode prepared by using the electrode active material slurry according to Comparative Example 1, which has a general composition of the electrode active material slurry, had capacitance of 10.78 F and resistance of 19.03 mΩ.

In contrast, an electrochemical capacitor (EDLC cell) according to Example 3, which includes an electrode prepared by using the electrode active material slurry according to Example 2, which uses the surface-modified activated carbon, had capacitance of 13.21 F and resistance of 18.77 mΩ.

From these results, it can be confirmed that a cell exhibiting high capacitance and high output characteristics through the structure of the above activated carbon can be manufactured.

According to the present invention, there can be provided an electrode active material for an electrochemical capacitor having improved performances in which capacitance per unit weight is large, inner resistance is small, and performance is not largely deteriorated even at high current.

Furthermore, high-priced activated carbon mainly dependent on imports can be substituted with low-priced activated carbon prepared by double surface treatment as described in the present invention, and thus superior economical effects can be obtained.

According to the present invention, a high-capacitance and high-output electrochemical capacitor can be provided by using the electrode active material.

While the present invention has been shown and described in connection with the embodiments, it will be apparent to those skilled in the art that modifications and variations can be made without departing from the spirit and scope of the invention as defined by the appended claims.

What is claimed is:

1. An electrode active material, comprising:
a first layer formed on a surface of activated carbon and having a porous structure; and
a second layer formed on the first layer and having polar groups.

2. The electrode active material according to claim 1, wherein the electrode active material has a specific surface area of 2,000 to 3,000 m²/g.

3. The electrode active material according to claim 1, wherein the polar groups of the second layer are obtained by substitution of carbon bonds on a surface of the first layer.

4. The electrode active material according to claim 1, wherein the polar group of the second layer is at least one nitrogen-containing material selected from the group consisting of a C═N group, an amino group, a cyclic amide group, a nitrile group (RCN, wherein R is a hydrocarbon group), and a 5-membered heterocyclic compound containing one nitrogen atom in a ring thereof.

5. The electrode active material according to claim 1, wherein the second layer is formed to have a thickness of 10 nm or less.

6. A method for preparing an electrode active material, comprising:
performing heat treatment on activated carbon to form a first layer having a porous structure; and
substituting carbon bonds on a surface of the first layer with polar groups to form a second layer having the polar groups.

7. The method according to claim 6, wherein the heat treatment is performed by using an aqueous alkaline solution.

8. The method according to claim 6, wherein the heat treatment is performed at a temperature of 300 to 700° C. for 1 to 3 hours.

9. The method according to claim 6, wherein the substituting with the polar group is performed by one method selected from plasma treatment, nitric acid oxidation, and ammonia treatment.

10. An electrochemical capacitor including an electrode using the electrode active material according to claim 1.
